(19) United States
(12) Patent Application Publication
(10) Pub. No.: US 2014/0184552 A1
(43) Pub. Date: Jul. 3, 2014

(54) NEAR-FIELD AND FAR-FIELD CAPACITIVE SENSING

(71) Applicant: SYNAPTICS INCORPORATED, Santa Clara, CA (US)

(72) Inventor: Tetsuo TANEMURA, Yokohama (JP)

(73) Assignee: SYNAPTICS INCORPORATED, Santa Clara, CA (US)

(21) Appl. No.: 13/728,766

(22) Filed: Dec. 27, 2012

(51) Int. Cl. G06F 3/044

(52) U.S. Cl. CPC G06F 3/044
USPC 345/174

(57) ABSTRACT

A capacitive input device processing system includes a transmitter module with transmitter circuitry configured to drive a plurality of transmitter electrodes with transmitter signals. A first receiver module is configured to receive near-field resulting signals from a plurality of near-field receiver electrodes. The near-field resulting signals comprise near-field effects corresponding to the transmitter signals and related to a first portion of a sensing region which is at or near a surface of a capacitive input device. A second receiver module is configured to receive far-field resulting signals from a plurality of far-field receiver electrodes. The far-field resulting signals comprise far-field effects corresponding to the transmitter signals and related to a second portion of the sensing region which extends further from the surface of the capacitive input device than the first portion of the sensing region. The processing system is configured to simultaneously receive the near-field and far-field resulting signals.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones and tablet computers). Such touch screen input devices are typically superimposed upon or otherwise collocated with a display of the electronic device.

### SUMMARY

According to various embodiments described herein, a capacitive input device processing system comprises a transmitter module, a first receiver module, and a second receiver module. The transmitter module includes transmitter circuitry configured to drive a plurality of transmitter electrodes with transmitter signals. The first receiver module is configured to receive near-field resulting signals from a plurality of near-field receiver electrodes. The near-field resulting signals comprise near-field effects corresponding to the transmitter signals and related to a first portion of a sensing region which is at or near a surface of a capacitive input device. The second receiver module is configured to receive far-field resulting signals from a plurality of far-field receiver electrodes. The far-field resulting signals comprise far-field effects corresponding to the transmitter signals and related to a second portion of the sensing region which extends further from the surface of the capacitive input device than the first portion of the sensing region. The processing system is configured to simultaneously receive the near-field and far-field resulting signals.

### BRIEF DESCRIPTION OF DRAWINGS

The drawings referred to in this Brief Description of Drawings should not be understood as being drawn to scale unless specifically noted. The accompanying drawings, which are incorporated in and form a part of the Description of Embodiments, illustrate various embodiments and, together with the Description of Embodiments, serve to explain principles discussed below, where like designations denote like elements, and:

FIG. 1 is a block diagram of an example input device, in accordance with embodiments;

FIG. 2A shows a portion of an example sensor electrode pattern which includes both near-field and far-field receiver electrodes and which may be utilized in a sensor to generate all or part of the sensing region of an input device, according to some embodiments;

FIG. 2B shows a portion of an example sensor electrode pattern which includes both near-field and far-field receiver electrodes and which may be utilized in a sensor to generate all or part of the sensing region of an input device, according to some embodiments;

FIG. 2C shows a portion of an example sensor electrode pattern which includes both near-field and far-field receiver electrodes and which may be utilized in a sensor to generate all or part of the sensing region of an input device, according to some embodiments;

FIG. 3 illustrates an example processing system, according to various embodiments; and

FIG. 4 illustrates a flow diagram of an example method of switching between use of near-field and far-field receiver electrodes of an input device, according to various embodiments.

### DESCRIPTION OF EMBODIMENTS

The following Description of Embodiments is merely provided by way of example and not of limitation. Furthermore, there is no intention to be bound by any expressed or implied theory presented in the preceding Background, Summary, or Brief Description of Drawings or the following Description of Embodiments.

### Overview of Discussion

Herein, various embodiments are described that provide input devices, processing systems, and methods that facilitate improved usability. In various embodiments described herein, the input device devices discussed are capacitive input devices. Embodiments associated with capacitive input device near-field and far-field input object sensing.

Discussion begins with a description of an example input device with which or upon which various embodiments described herein may be implemented. Some non-limiting examples of sensor electrode pattern which include both near-field and far-field receiver electrodes are described. This is followed by description of an example processing system and some components thereof. The processing system may be utilized with an input device, such as a capacitive sensing device. Operation of the capacitive input device, processing system, and components thereof are then further described in conjunction with description of an example method of switching between use of near-field and far-field receiver electrodes of an input device.

### Example Input Device

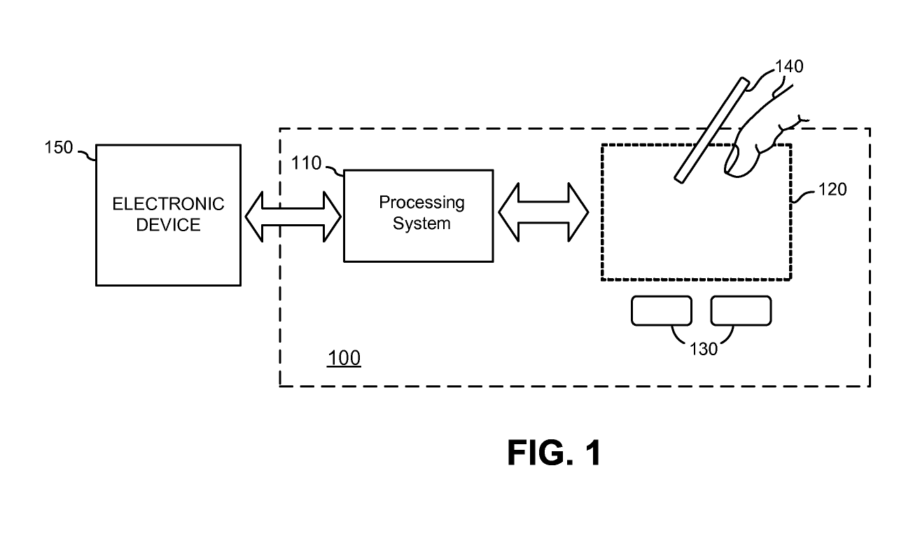

Turning now to the figures, FIG. 1 is a block diagram of an exemplary input device 100, in accordance with various embodiments. Input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

Input device 100 can be implemented as a physical part of the electronic system, or can be physically separate from the electronic system. As appropriate, input device 100 may communicate with parts of the electronic system using any one or more of the following: buses, networks, and other wired or wireless interconnections. Examples include, but are not limited to: Inter-Integrated Circuit (I2C), Serial Peripheral Interface (SPI), Personal System 2 (PS/2), Universal Serial Bus (USB), Bluetooth®, Radio Frequency (RF), and Infrared Data Association (IrDA).

In FIG. 1, input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near input device 100, in which input device 100 is able to detect user input (e.g., user input provided by one or more input objects 140). The sizes, shapes, and locations of particular sensing regions may vary widely from embodiment to embodiment. In some embodiments, sensing region 120 extends from a surface of input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of input device 100, contact with an input surface (e.g., a touch surface) of input device 100, contact with an input surface of input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, sensing region 120 has a rectangular shape when projected onto an input surface of input device 100.

Input device 100 may utilize any combination of sensor components and sensing technologies to detect user input in sensing region 120. Input device 100 comprises one or more sensing elements for detecting user input. As a non-limiting example, input device 100 may use capacitive techniques.

Some implementations are configured to provide images that span one, two, three, or higher dimensional spaces. Some implementations are configured to provide projections of input along particular axes or planes.

In some capacitive implementations of input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Collectively transmitters and receivers may be referred to as sensor electrodes or sensor elements. Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g., other electromagnetic signals). Sensor electrodes may be dedicated transmitters or receivers, or may be configured to both transmit and receive. In some embodiments, one or more receiver electrodes may be operated to receive a resulting signal when no transmitter electrodes are transmitting (e.g., the transmitters are disabled). In this manner, the resulting signal represents noise detected in the operating environment of sensing region 120.

In FIG. 1, a processing system 110 is shown as part of input device 100. Processing system 110 is configured to operate the hardware of input device 100 to detect input in sensing region 120. Processing system 110 comprises parts of or all of one or more integrated circuits (ICs) and/or other circuitry components. (For example, a processing system for a mutual capacitance sensor device may comprise transmitter circuitry configured to transmit signals with transmitter sensor electrodes, and/or receiver circuitry configured to receive signals with receiver sensor electrodes). In some embodiments, processing system 110 also comprises electronically-readable instructions, such as firmware code, software code, and/or the like. In some embodiments, components composing processing system 110 are located together, such as near sensing element(s) of input device 100. In other embodiments, components of processing system 110 are physically separate with one or more components close to sensing element(s) of input device 100, and one or more components elsewhere. For example, input device 100 may be a peripheral coupled to a desktop computer, and processing system 110 may comprise software configured to run on a central processing unit of the desktop computer and one or more ICs (perhaps with associated firmware) separate from the central processing unit. As another example, input device 100 may be physically integrated in a phone, and processing system 110 may comprise circuits and firmware that are part of a main processor of the phone. In some embodiments, processing system 110 is dedicated to implementing input device 100. In other embodiments, processing system 110 also performs other functions, such as operating display screens, driving haptic actuators, etc.

Processing system 110 may be implemented as a set of modules that handle different functions of processing system 110. Each module may comprise circuitry that is a part of processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, processing system 110 responds to user input (or lack of user input) in sensing region 120 directly by causing one or more actions. Example actions include changing operation modes, as well as GUI actions such as cursor movement, selection, menu navigation, and other functions. In some embodiments, processing system 110 provides information about the input (or lack of input) to some part of the electronic system (e.g., to a central processing system of the electronic system that is separate from processing system 110, if such a separate central processing system exists). In some embodiments, some part of the electronic system processes information received from processing system 110 to act on user input, such as to facilitate a full range of actions, including mode changing actions and GUI actions.

For example, in some embodiments, processing system 110 operates the sensing element(s) of input device 100 to produce electrical signals indicative of input (or lack of input) in sensing region 120. Processing system 110 may perform any appropriate amount of processing on the electrical signals in producing the information provided to the electronic system. For example, processing system 110 may digitize analog electrical signals obtained from the sensor electrodes. As another example, processing system 110 may perform filtering or other signal conditioning. As yet another example, processing system 110 may subtract or otherwise account for a baseline, such that the information reflects a difference between the electrical signals and the baseline. As yet further examples, processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, input device 100 is implemented with additional input components that are operated by processing system 110 or by some other processing system. These additional input components may provide redundant functionality for input in sensing region 120, or some other functionality. FIG. 1 shows buttons 130 near sensing region 120 that can be used to facilitate selection of items using input device 100. Other types of additional input components include sliders, balls, wheels, switches, and the like. Conversely, in some embodiments, input device 100 may be implemented with no other input components.

In some embodiments, input device 100 may be a touch screen, and sensing region 120 overlaps at least part of an active area of a display screen. For example, input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. Input device 100 and the display screen may share physical elements. For example, some embodiments may utilize some of the same electrical components for displaying and sensing. As another example, the display screen may be operated in part or in total by processing system 110.

It should be understood that while many embodiments are described in the context of a fully functioning apparatus, the mechanisms are capable of being distributed as a program product (e.g., software) in a variety of forms. For example, the mechanisms that are described may be implemented and distributed as a software program on information bearing media that are readable by electronic processors (e.g., non-transitory computer-readable and/or recordable/writable information bearing media readable by processing system 110). Additionally, the embodiments apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other tangible storage technology.

### Example Sensor Electrode Pattern

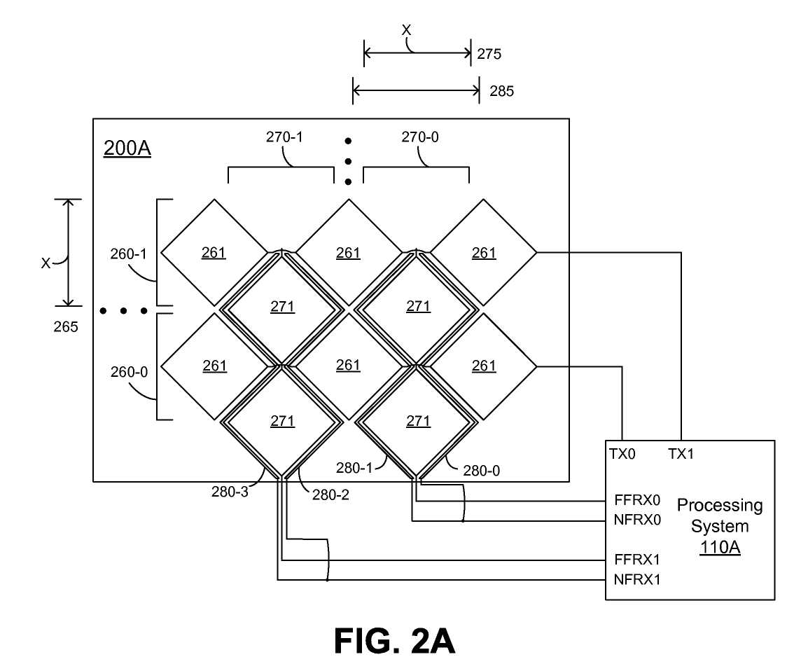

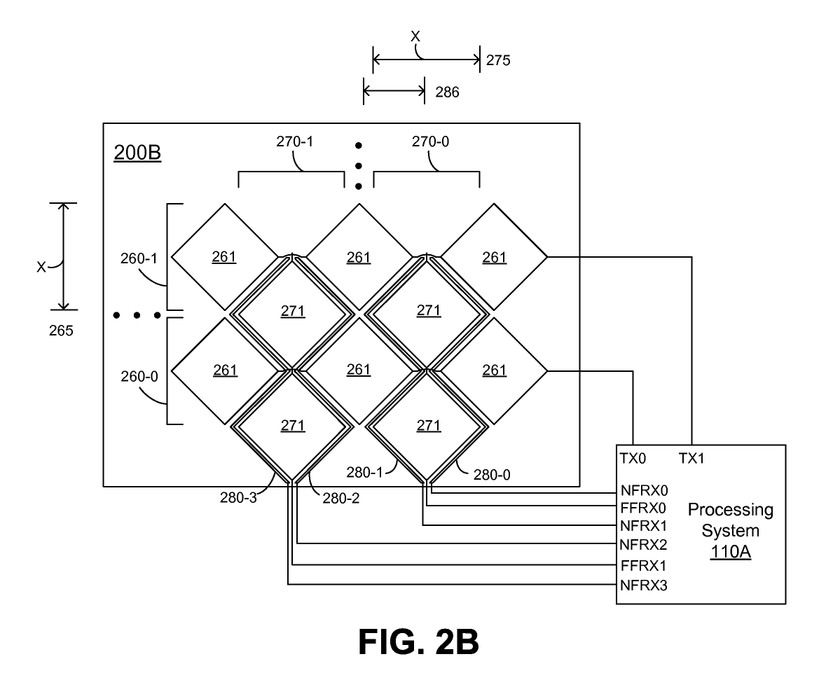

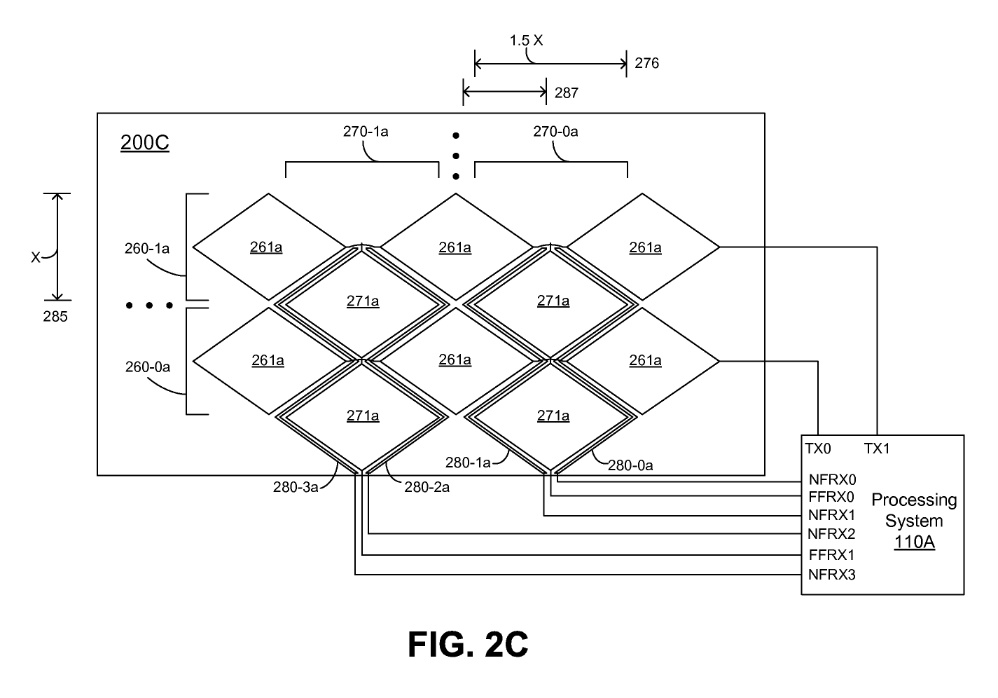

FIG. 2A shows a portion of an example sensor electrode pattern 200A which includes both near-field receiver electrodes 280 and far-field receiver electrodes 270, and which may be utilized in a sensor to generate all or part of the sensing region 120 of an input device 100, according to some embodiments. Input device 100 of FIG. 1 (or the like) is configured as a capacitive input device when utilized with a capacitive sensor electrode pattern. For purposes of clarity of illustration and description, a non-limiting simple capacitive sensor electrode pattern 200A is illustrated in FIG. 2A. It is appreciated that numerous other sensor electrode patterns may be employed in a similar manner, and some non-limiting additional examples are illustrated in FIGS. 2B and 2C.

In FIG. 2A, the illustrated sensor electrode pattern is made up of a plurality of near-field receiver electrodes 280 (280-0, 280-1, 280-3, 280-4, etc.), a plurality of far-field receiver electrodes 270 (270-0, 270-1, etc.), and a plurality of transmitter electrodes 260 (260-0, 260-1, etc.) which overlay one another, in this example. The transmitter electrodes 260 are disposed orthogonally to the far-field receiver electrodes 270 and orthogonally to the near-field receiver electrodes 280. The transmitter electrodes are depicted as being coupled to transmitter outputs (e.g., TX0, TX1, etc.) of processing system 110A, and are used to transmit transmitter signals which are received as near-field resulting signals by both near-field receiver electrodes 280 and as far-field resulting signals by far-field receiver electrodes 270. Far-field receiver electrodes 270 are depicted as being coupled to far-field receiver inputs (e.g., FFRX0, FFRX1, etc.) of processing system 110A so that far-field resulting signals can be supplied to processing system 100A. Near-field receiver electrodes 280 are depicted as being coupled to near-field receiver inputs (e.g., NFRX0, FFRX1, etc.) of processing system 110A so that near-field resulting signals can be supplied to processing system 110A. Processing system 110A can receive near-field resulting signals and far-field resulting signals at different times or simultaneously.

As depicted in FIG. 2A, a plurality of diamond shaped electrode elements 271 are ohmically coupled with one another to form a far-field receiver electrode 270 (e.g., 270-0), and a plurality of diamond shaped electrode elements 261 are ohmically coupled together to form a transmitter electrode 260 (e.g., 260-1). In one embodiment transmitter electrodes 260 and far-field receiver electrodes 270 have similar or identical shape and surface area to one another. Although a diamond pattern is illustrated, in FIG. 2A, other shapes may be utilized, including bar shaped electrodes for transmitter electrodes 260 and far-field receiver electrodes 270. By contrast, near-field receiver electrodes 280 have a much different and thinner shape and a substantially smaller surface area than either transmitter electrodes 260 or far-field receiver electrodes 270. As can be seen, two near-field receiver electrodes 280 (e.g., 280-0 and 280-1) outline the edges of a far-field receiver electrode 270 (e.g., 270-0) and, in some embodiments, like in a gap between elements of a far-field receiver electrode 270 (e.g., 270-0) and adjacent transmitter electrode elements.

With respect to surface area, the surface area of any near-field receiver electrode 280 is less than the surface area of any far-field receiver electrode 270. By decreasing the surface area of near-field receiver electrodes 280 as compared to the surface area of far-field receiver electrodes 270, there is a reduction in the excessive electric field lines being coupled back to the near-field receiver electrodes from the transmitter electrodes in response to input object contact with a sensing surface of input device 100. Likewise, the greater surface area of the far-field receiver electrodes 270 allows a greater projection of electric field lines above an input surface for intercept by an input object 140. In other words, the greater surface area of far-field receiver electrodes 270 allows them to work more efficiently to detect far-field input object interactions, while the comparatively thin shape and smaller surface area of near-field receiver electrodes 280 allows them to operate more efficiently to detect near-field input object interactions.

In the illustrated example, a near-field capacitive pixel is centered at each location where a transmitter electrode 260 and a near-field receiver electrode 280 cross; and a far-field capacitive pixel is centered at a location where a transmitter electrode 260 and a far-field receiver electrode 270 cross. It is appreciated that in a crossing sensor electrode pattern, such as the illustrated example, some form of insulating material or substrate is typically disposed between transmitter electrodes 260 and receiver electrodes 270/280 to prevent ohmic coupling. However, in some embodiments, transmitter electrodes 260 and one or more of far-field receiver electrodes 270 and near-field receiver electrodes 280 may be disposed on the same layer as one another through use of routing techniques, jumpers, or/or selective use of insulating material. In some embodiments transmitter electrodes 260 and one of either near-field receiver electrodes 280 or far-field receiver electrodes 270 are disposed on the same side of a substrate as one another. In some embodiments, all of transmitter electrodes 260, near-field receiver electrodes 280, and far-field receiver electrodes 270 are all disposed on the same side of a substrate as one another. In some embodiments, one or more of transmitter electrodes 260, near-field receiver electrodes 280, and far-field receiver electrodes 270 are disposed on different substrates all together or on different sides of the same substrate. For example, in one embodiment, transmitter electrodes 260 may be disposed on a first side of a first substrate while near-field receiver electrodes 280 and far-field receiver electrodes 270 are disposed on a second and opposing side of the same substrate. In another embodiment, transmitter electrodes 260 may be disposed on a first side of a first substrate while near-field receiver electrodes 280 and far-field receiver electrodes 270 are disposed on the same or opposing sides of a second substrate.

Herein, near-field sensing is accomplished by receiving near-field resulting signals with near-field receiver electrodes 280. The near-field resulting signals comprise near-field effects corresponding to the transmitter signals and related to a first portion of a sensing region 120 which is at or near an input surface of capacitive input device 100.

For example, various embodiments, near-field sensing includes sensing input objects 140 in sensing region 120 that are in contact with or nearly in contact with (e.g., within about a 10 mm in some embodiments) of an input surface (e.g., a touch surface) of input device 100. It should be appreciated that the range of near-field sensing above an input surface may be larger or smaller in some embodiments and that, in some embodiments, near-field sensing may include only sensing of input objects that are in contact with an input surface of input device 100.

Near-field capacitive pixels are areas of localized capacitive coupling between transmitter electrodes 260 and near-field receiver electrodes 280. The capacitive coupling between transmitter electrodes 260 and near-field receiver electrodes 280 changes with the proximity and motion of input objects in the sensing region associated with transmitter electrodes 260 and near-field receiver electrodes 280.

In various embodiments, far-field sensing includes sensing input objects in sensing region 120 that are somewhere above, but not in contact with, with an input surface (e.g., touch surface) of input device 100. As a non-limiting example, far-field sensing, in one embodiment may take place in a second portion of a sensing region 120 that is between approximately 3 mm and 50 mm above an input surface of input device 100. It should be appreciated that the lower and upper bounds of a far-field sensing region may be different in other embodiments and that many ranges of far-field sensing above an input surface are possible. For example, in one embodiment the far-field sensing region may be between 5 mm and 20 mm above an input surface of input device 100. Though in many instances a lower portion of the range of far-field sensing may overlap with some portion of an upper portion of a sensing range of near-field sensing, the far-field sensing region extends further from an input surface of an input device 100 than the near-field sensing region extends.

Herein, far-field sensing is accomplished by receiving far-field resulting signals with far-field receiver electrodes 270. Far-field resulting signals comprise far-field effects corresponding to transmitter signals transmitted from transmitter electrodes 260 and related to the second portion (the far-field sensing region) of sensing region 120 which extends further from the surface of the capacitive input device 100 than first portion (the near-field sensing region) of sensing region 120.

Far-field capacitive pixels are areas of localized capacitive coupling between transmitter electrodes 260 and far-field receiver electrodes 270. The capacitive coupling between transmitter electrodes 260 and far-field receiver electrodes 270 changes with the proximity and motion of input objects in the sensing region associated with transmitter electrodes 260 and far-field receiver electrodes 270.

In some embodiments, sensor electrode pattern 200A is “scanned” to determine these capacitive couplings. That is, the transmitter electrodes 260 are driven to transmit transmitter signals. Transmitter electrodes 260 may be operated such that one transmitter electrode transmits at one time, or multiple transmitter electrodes transmit at the same time. Where multiple transmitter electrodes 260 transmit simultaneously, these multiple transmitter electrodes may transmit the same transmitter signal and produce an effectively larger transmitter electrode, or these multiple transmitter electrodes may transmit different transmitter signals. For example, multiple transmitter electrodes may transmit different transmitter signals according to one or more coding schemes that enable their combined effects on the resulting signals of far-receiver electrodes 270 and/or near-field receiver electrodes 280 to be independently determined.

Far-field receiver electrodes 270 may be operated singly or multiply to acquire far-field resulting signals. The received far-field resulting signals may be used by a processing system to determine measurements of the capacitive couplings at the far-field capacitive pixels and to create a far-field capacitive image.

Likewise, near-field receiver electrodes 280 may be operated singly or multiply. The received near-field resulting signals may be used by a processing system to determine measurements of the capacitive couplings at the near-field capacitive pixels and to create a near-field capacitive image. It should be appreciated that the near-field and far-field receiver electrodes may operate at separate times from one another or simultaneously with one another. When operating simultaneously, the near-field receiver electrode(s) and the far-field receiver electrode(s) are configured to simultaneously couple with the transmitter electrode(s) that is/are transmitting transmitter signals.

A set of measurements from the capacitive pixels form a “capacitive image” (also “capacitive frame”) representative of the capacitive couplings at the pixels. Multiple capacitive images may be acquired over multiple time periods, and differences between them used to derive information about input in the sensing region. For example, successive far-field capacitive images acquired over successive periods of time can be used to track the motion(s) of one or more input objects 140 entering, exiting, and within the far-field portion of a sensing region 120. Likewise, successive near-field capacitive images acquired over successive periods of time can be used to track the motion(s) of one or more input objects 140 entering, exiting, and within the near-field portion of a sensing region 120.

As can be seen, in the embodiment of FIG. 2A, far-field receiver electrodes 260 have substantially the same pitch 275 of distance X as the pitch 265 of transmitter electrodes 260. Likewise, while slightly greater, the pitch 285 of near-field receiver electrodes 280 is substantially similar to the pitch 275 of far-field receiver electrodes 270. As can be seen, the pitch 285 of near-field receiver electrodes 280, as shown in FIG. 2A, can be altered by coupling pairs of them together as illustrated in FIG. 2A or decoupling them as illustrated in FIG. 2B to form sensor electrode pattern 200B where pitch 286 is approximately half of pitch 285 in sensor electrode pattern 200A. Coupling pairs of near-field receiver electrodes 280 together, as shown in FIG. 2A, can reduce the number of near-field receiver inputs (NFRX) used by processing system 110A by effectively creating a single near-field receiver electrode out of two adjacent near-field receiver electrodes (e.g., 280-0 and 280-1) while increasing their pitch. The coupling can be accomplished physically either on a substrate upon which the near-field receiver electrodes are disposed or off of the substrate, or virtually within processing system 110A by summing responses. Physical coupling done externally to processing system 110A, reduces the number of near-field receiver inputs (NFRX) used by processing system 110A.

FIG. 2B shows a portion of an example sensor electrode pattern 200B which includes both near-field receiver electrodes 280 and far-field receiver electrodes 270, and which may be utilized in a sensor to generate all or part of the sensing region 120 of an input device 100, according to some embodiments. Sensor electrode pattern 200B operates in the same fashion as sensor electrode pattern 200A except that pairs of near-field receiver electrodes 280 are not coupled with one another. This utilizes a greater number of near-field receiver inputs (NFRX0-NFRX3) for a similar layout and decreases the pitch, but increases near-field response by increasing the number of near-field capacitive pixels in a near-field capacitive image to effectively double the number of far-field capacitive pixels in a far-field capacitive image (this give finer near-field resolution), as opposed to the capacitive images of FIG. 2A which would have a similar number of capacitive pixels in near and far-field capacitive images (near-field and far-field resolution are similar).

FIG. 2C shows a portion of an example sensor electrode pattern 200C which includes both near-field receiver electrodes 280 and far-field receiver electrodes 270, and which may be utilized in a sensor to generate all or part of the sensing region 120 of an input device 100, according to some embodiments. The pitch 275 of a far-field receiver electrode 270 (e.g., 270-1) is defined as a distance X in FIGS. 2A and 2B. However, FIG. 2C depicts an embodiment where the width and thus the pitch has been stretched, such as to 1.5×, so that a new pitch 276 is achieved and a smaller number of far-field receiver electrodes 270 is needed to cover a given area. Such stretching in one dimension can also reduce the number of far-field receiver inputs needed to service a given area as compared to the sensor electrode pattern embodiments shown in FIGS. 2A and 2B.

Sensor electrode pattern 200C is constructed in and operates in the same fashion as sensor electrode pattern 200B except that electrodes have been stretched. For example, far-field receiver electrodes 270 (270-0a, 270-1a, etc.) have been stretched in the one dimension to a greater width. For example, the width of electrode elements 271a is approximately 1.5× versus a width of X for electrode elements 271 in sensor electrode pattern 200B. This creates new far-field receiver electrode pitch 276. Electrode elements 261a have also been stretched in one dimension a similar amount in comparison to their counterpart electrode elements 261 in sensor electrode pattern 200B, and thus transmitter electrodes 260 (260-0a, 260-1a, etc.) are slightly elongated in comparison to transmitter electrodes 260 of sensor electrode pattern 200B and a new near-field receiver electrode pitch 287 is achieved. Likewise, in order to accommodate the stretched dimension of far-field receiver electrodes 270, the overall length and positioning of near-field receiver electrodes 280a (280-0a, 280-1a, 280-2a, 280-3a, etc.) has also been stretched in one dimension in comparison to near-field receiver electrodes 280 of sensor electrode pattern 200B. However, as pitch of transmitter electrodes 260 is measured in a direction that is orthogonal to the measure of pitch in receiver electrodes 270 and 280, pitch 265 remains unchanged from sensor electrode patterns 200A and 200B.

### Example Processing System

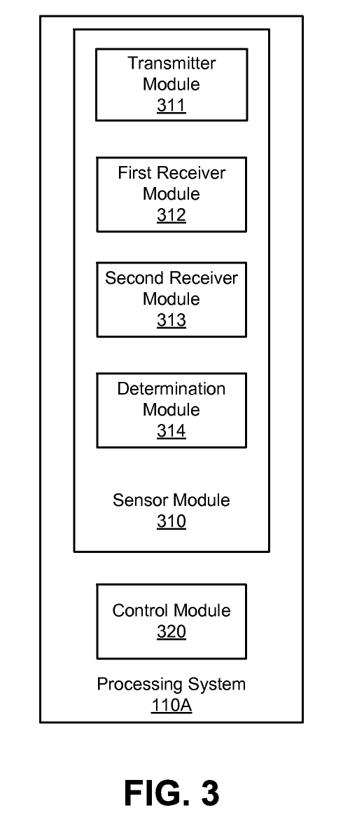

FIG. 3 illustrates a block diagram of some components of an example processing system 110A that may be utilized with an input device (e.g., in place of processing system 110 as part of input device 100), according to various embodiments. Processing system 110A may be implemented with one or more Application Specific Integrated Circuits (ASICSs), one or more Integrated Circuits (ICs), one or more controllers, or some combination thereof. In one embodiment, processing system 110A is communicatively coupled with one or more transmitter electrode(s) and receiver electrode(s) that implement a sensing region 120 of an input device 100. In some embodiments, processing system 110A and the input device 100, of which it is a part, may be disposed in or communicatively coupled with an electronic device 150, such as a display device, computer, or other electronic device.

In one embodiment of input device 100, processing system 110A includes, among other components: a sensor module 310, and a control module 320. Processing system 110A and/or components thereof may be coupled with sensor electrodes of a sensor electrode pattern, such as sensor electrode pattern 200. For example, sensor module 310 is coupled with one or more sensor electrodes of a sensor electrode pattern (e.g., sensor electrode pattern 200A, 200B, 200C, or the like) of input device 100.

Sensor module 310 operates to interact with receiver and transmitter sensor electrodes of a sensor pattern that is utilized to generate a sensing region 120. This includes operating transmitter electrodes to be silent or transmit a transmitter signal. This also includes utilizing near-field receiver electrodes 280 and/or far-field receiver electrodes 270 to receive resulting signals. Sensor module 310 may also determine from received resulting signal(s) that an input has occurred in sensing region 120, as well as determining a location of the input with respect to sensing region 120. As depicted in FIG. 3, sensor module 310 may include one or more of transmitter module 311, first receiver module 312, second receiver module 313, and determination module 314.

Transmitter module 311 includes circuitry such as selectable switches and amplifiers and operates to drive transmitter signals on one or more transmitter electrodes 160. In a given time interval, transmitter module 311 may transmit or not transmit a transmitter signal (waveform) on one or more of a plurality of transmitter electrodes 160. Transmitter module 311 may also be utilized to couple one or more transmitter electrodes 160 (and respective transmitter path(s)) of a plurality of transmitter electrodes 160 to high impedance, ground, or to a constant voltage when not driving a waveform on such transmitter electrodes. The transmitter signal(s) may be a square wave, trapezoidal wave, or some other waveform. Transmitter module 311 may code a transmitter signal, such as in a code division multiplexing scheme. The code may be altered, such as lengthening or shortening the code, under direction of control module 320. For example, lengthening the code is one technique for avoiding interference.

First receiver module 312 operates to receive near-field resulting signals, via near-field receiver electrodes 280. The received near-field resulting signals correspond to and include some version of the transmitter signal(s) transmitted via the transmitter electrodes. These transmitted transmitter signals however, may be altered or changed in the resulting signal due to the presence of an input object in a near-field portion of sensing region 120, and/or the presence of stray capacitance, noise, interference, and/or circuit imperfections among other factors, and thus resulting signals may differ slightly or greatly from their transmitted versions. Near-field resulting signals may be received at processing system 110A from one or a plurality of near-field receiver electrodes 280 at a particular time and may be received at the same time as the receipt of far-field resulting signals by processing system 110. In some embodiments, first receiver module 312 includes a plurality of amplifiers, typically one per receiver electrode.

Second receiver module 313 operates to receive far-field resulting signals, via far-field receiver electrodes 270. The received far-field resulting signals correspond to and include some version of the transmitter signal(s) transmitted via the transmitter electrodes. These transmitted transmitter signals however, may be altered or changed in the resulting signal due to the presence of an input object in a far-field portion of sensing region 120, and/or the presence of stray capacitance, noise, interference, and/or circuit imperfections among other factors, and thus resulting signals may differ slightly or greatly from their transmitted versions. As previously mentioned, the far-field portion of sensing region 120 extends further from a surface (e.g., touch input receiving surface) of capacitive input device 100 than does the near-field portion of sensing region 120. Far-field resulting signals may be received at processing system 110A from one or a plurality of far-field receiver electrodes 270 at a particular time and may be received at the same time as the receipt of near-field resulting signals by processing system 110. In some embodiments, second receiver module 313 includes a plurality of amplifiers, typically one per receiver electrode.

Determination module 314 operates to compute/determine a measurement of a change in a capacitive coupling between a transmitter electrode 260 and a near-field receiver electrode 280 or between a transmitter electrode 260 and a far-field receiver electrode 270. Determination module 314 uses near-field measurements to determine a respective near-field capacitive image which will depict the position of an input object (if any) with respect to a near-field portion of sensing region 120. Determination module 314 similarly uses far-field measurements to determine a respective far-field capacitive image which will depict the position of an input object (if any) with respect to a far-field portion of sensing region 120. Depending on the number and configuration of near-field and far-field receiver electrodes employed in a sensor electrode pattern, the near-field and far-field capacitive images may have similar or different resolutions. In one embodiment, as previously described, the near-field capacitive image may have much finer resolution due to the use of approximately twice the number of near-field receiver electrodes 280 as compared to the number of far-field receiver electrodes 270.

With reference to sensor electrode pattern 200A of FIG. 2A, in some embodiments, a first near-field resulting signal of a plurality of near-field resulting signals and a second near-field resulting signal of the plurality of near-field resulting signals correspond to a first capacitive pixel of a near-field capacitive image. For example, in an embodiment where a first far-field receiver electrode, such as 270-0 of FIG. 2A, is disposed between a first near-field receiver electrode (e.g., 280-0) and a second near-field receiver electrode (280-1), the first near-field resulting signal corresponds to near-field receiver electrode 280-0 and the second near-field resulting signal corresponds to near-field receiver electrode 280-1, such near-field resulting signals can be combined within processing system 110A to create a single capacitive pixel of an near-field capacitive image if the respective near-field receiver electrodes not physically coupled to one another as illustrated in FIG. 2A.

With reference to sensor electrode pattern 200B of FIG. 2B, in some embodiments, a first near-field resulting signal of a plurality of near-field resulting signals corresponds to a first capacitive pixel of a near-field capacitive image and a second near-field resulting signal of the plurality of near-field resulting signals corresponds to a second capacitive pixel of the near-field capacitive image. For example, in an embodiment where a first far-field receiver electrode, such as 270-0 of FIG. 2B, is disposed between a first near-field receiver electrode (e.g., 280-0) and a second near-field receiver electrode (280-1), the first near-field resulting signal corresponds to near-field receiver electrode 280-0 and the second near-field resulting signal corresponds to near-field receiver electrode 280-1.

Control module 320 comprises decision making logic which directs processing system 110A and sensor module 310 to operate in a selected one of a plurality of different operating modes based on various inputs. Control module 320 may be implemented as hardware (e.g., hardware logic and/or other circuitry) and/or as a combination of hardware and instructions stored in a non-transitory manner in a computer readable storage medium. In some embodiments, control module 320 or other portion of processing system 110A may direct sensor module 310 to acquire a baseline near-field capacitive image and/or a baseline far-field capacitive image. In some embodiments, such baseline images are used for comparison purposes and to determine the presence of interference in an operating environment. In some modes of operation, control module 320 or other portion of processing system 110A may direct that near-field resulting signals are not received by processing system 110A or that any received near-field resulting signals and/or generated near-field capacitive image is ignored. This can occur, for instance for power savings and/or when operating in a hover detection mode where the interest is in input within the far-field portion of sensing region 120. In some modes of operation, control module 320 or other portion of processing system 110A may direct that far-field resulting signals are not received by processing system 110A or that any received far-field resulting signals and/or generated far-field capacitive image is ignored. This can occur, for instance for power savings and/or when operating in a touch detection mode where the interest is in input within the near-field portion of sensing region 120.

### Example Method of Operation

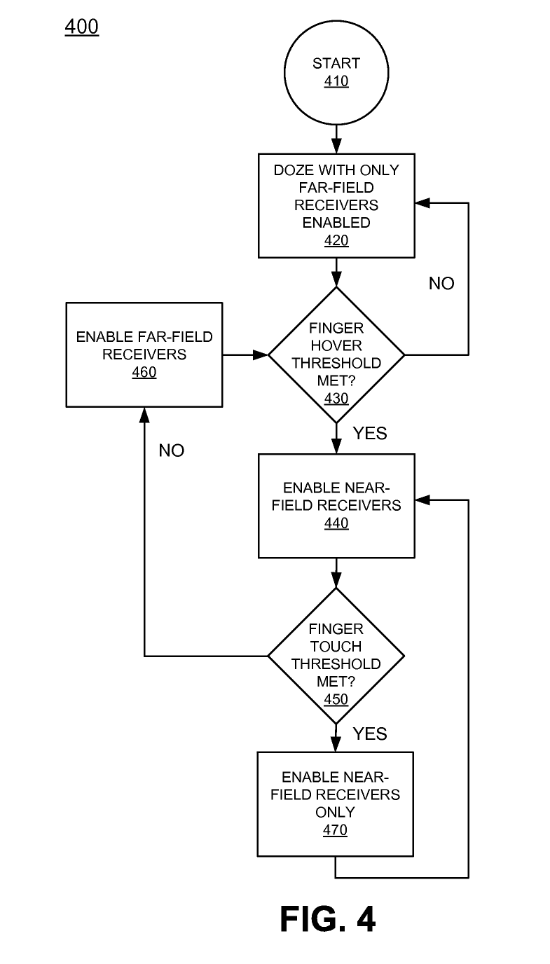

FIG. 4 illustrates a flow diagram 400 of an example method of switching between use of near-field and far-field receiver electrodes of an input device, according to various embodiments. Procedures described in flow diagram 400 may be implemented by control module 320 or other portions of processing systems described herein using sensor electrode patterns 200A, 200B, 200C, or the like which include near-field and far-field receiver electrodes in the manner described herein.

The method begins at procedure 410 and moves to procedure 420 where a processing system 110 operates in a doze mode that involves only enabling receipt of resulting signals from far-field receiver electrodes 270. By not operating processing system 110 to receive and process near-field resulting signals, power of an electronic device 150 is conserved. It should further be appreciated that, in some embodiments, operating in the doze mode further includes operating transmitter electrodes 260 and far-field receiver electrodes 270 at a lower duty cycle than when not in the doze mode.

At procedure 430 a check is made to see if a hovering input threshold associated with a finger or other input object in a far-field sensing region has been met or exceeded. If not, the method returns to procedure 420 in a loop. If so, this may indicate that an input object 140 is about provide touch input within a near-field sensing region of a sensing region 120, so sensing with near-field receiver electrodes is enabled at procedure 440 for a present period of time and touch inputs within the near-field portion of sensing region 120 are looked for.

At procedure 450, in the event that a near-field input is detected which meets or exceeds a preset near-field (touch) input object threshold, it can be expected that near-field inputs (e.g., touch inputs or nearly touching inputs) are taking place or are about to take place. In response to meeting or exceeding the near-field input object threshold at procedure 450, procedure 470 is executed in which only the near-field receiver electrodes remain enabled. For example, at procedure 470 processing system can ignore received far-field resulting signals and/or far-field capacitive images or disable receipt of far-field capacitive images. In some embodiments, the method remains at procedure 470 for a preset minimum amount of time after each instance that the near-field input object threshold is noted as being met or exceeded. In some embodiments, a watchdog timer may be implemented to account to allow exit after some preset long period of the near-field input object threshold being met or exceeded.

Returning to procedure 450, when the near-field input object threshold is no longer met or exceeded and some minimum time has passed since it last was, the method moves to procedure 460 where far-field sensing with far-field receiver electrodes 270 is again enabled. At procedure 430 a far-field input object threshold is checked, if it is met or exceeded, the method moves again to procedure 440, if not the method moves to procedure 420 and the doze mode is reentered where near-field receiver electrodes 280 are again disabled.

It should be noted that as no time exists after the start of flow diagram 400 where sensing is not being conducted with either near-field receiver electrodes, far-field receiver electrodes, or both, that this method eliminates glitches in the conventional handoff where sensing in one field (e.g., far-field or near-field) must be ceased prior to initiation of sensing in the other field.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed.

What is claimed is:

1. A capacitive input device processing system, said processing system comprising:
a transmitter module comprising transmitter circuitry, said transmitter module configured to drive a plurality of transmitter electrodes with transmitter signals;
a first receiver module configured to receive near-field resulting signals from a plurality of near-field receiver electrodes, said near-field resulting signals comprising near-field effects corresponding to said transmitter signals and related to a first portion of a sensing region which is at or near a surface of a capacitive input device;
a second receiver module configured to receive far-field resulting signals from a plurality of far-field receiver electrodes, said far-field resulting signals comprising far-field effects corresponding to said transmitter signals and related to a second portion of said sensing region which extends further from said surface of said capacitive input device than said first portion of said sensing region; and
wherein said processing system is configured to simultaneously receive said near-field resulting signals and said far-field resulting signals.

2. The processing system of claim 1, further comprising:
a determination module configured to:
determine a near-field capacitive image based on said near-field resulting signals; and
determine a far-field capacitive image based on said far-field resulting signals.

3. The processing system of claim 2, wherein said near-field capacitive image and said far-field capacitive image comprise similar resolutions.

4. The processing system of claim 2, wherein said near-field capacitive image is of a finer resolution than said far-field capacitive image.

5. The processing system of claim 2, wherein said determination module is further configured to:
ignore either said near-field resulting signals or said near-field capacitive image based on said far-field capacitive image.

6. The processing system of claim 2, wherein said determination module is further configured to:
ignore said far-field resulting signals or said far-field capacitive image based on said near-field capacitive image.

7. The processing system of claim 2, determination module is further configured to:
acquire a first baseline image for near-field sensing in said first portion of said sensing region; and
acquire a second baseline image for far-field sensing in said second portion of said sensing region.

8. The processing system of claim 2, wherein a first near-field resulting signal of the near-field resulting signals and a second near-field resulting signal of the near-field resulting signals correspond to a first capacitive pixel of said near-field capacitive image, wherein a first far-field receiver electrode of said plurality of far-field electrodes is disposed between a first near-field receiver electrode and a second near-field receiver electrode of said plurality of near-field receiver electrodes, and wherein said first near-field resulting signal corresponds to said first near-field receiver electrode and said second near-field resulting signal corresponds to said second near-field receiver electrode.

9. The processing system of claim 2, wherein a first near-field resulting signal of said near-field resulting signals corresponds to a first capacitive pixel of said near-field capacitive image and a second near-field resulting signal of said near-field resulting signals corresponds to a second capacitive pixel of said near-field capacitive image, wherein a first far-field receiver electrode of said plurality of far-field electrodes is disposed between a first near-field receiver electrode and a second near-field receiver electrode of said plurality of near-field receiver electrodes, and wherein said first near-field resulting signal corresponds to said first near-field receiver electrode and said second near-field resulting signal corresponds to said second near-field receiver electrode.

10. A capacitive input device comprising:
a plurality of transmitter electrodes;
a plurality of near-field receiver electrodes;
a plurality of far-field receiver electrodes; and
a processing system coupled with said plurality of transmitter electrodes, said plurality of near-field receiver electrodes, and said plurality of far-field receiver electrodes wherein said processing system is configured to:
drive said plurality of transmitter electrodes with transmitter signals;
receive near-field resulting signals from said plurality of near-field receiver electrodes, said near-field resulting signals comprising near-field effects corresponding to said transmitter signals and related to a first portion of a sensing region which is at or near a surface of said capacitive input device; and
receive far-field resulting signals from a plurality of far-field receiver electrodes, said far-field resulting signals comprising far-field effects corresponding to said transmitter signals and related to a second portion of said sensing region which extends further from said surface of said capacitive input device than said first portion of said sensing region, wherein said processing system is configured to simultaneously receive said near-field resulting signals and said far-field resulting signals.

11. The capacitive input device of claim 10, further comprising:
a determination module configured to:
determine a near-field capacitive image based on said near-field resulting signals; and
determine a far-field capacitive image based on said far-field resulting signals.

12. The capacitive input device of claim 10, wherein at least one far-field receiver electrode is disposed between two near-field receiver electrodes.

13. The capacitive input device of claim 12, wherein said two near-field receiver electrodes correspond to a single capacitive pixel in a near-field capacitive image.

14. The capacitive input device of claim 12, wherein said two near-field receiver electrodes correspond to separate capacitive pixels in a near-field capacitive image.

15. A transcapacitive input device comprising:
a plurality of transmitter electrodes configured to transmit transmitter signals;
a plurality of near-field receiver electrodes configured to receive near-field resulting signals, said near-field resulting signals comprising near-field effects corresponding to said transmitter signals and related to a first portion of a sensing region which is at or near a surface of a capacitive input device; and
a plurality of far-field receiver electrodes configured to receive far-field resulting signals, said far-field resulting signals comprising far-field effects corresponding to said transmitter signals and related to a second portion of said sensing region which extends further from said surface of said capacitive input device than first portion of said sensing region, wherein at least one of said far-field receiver electrodes is disposed between a pair of said near-field receiver electrodes, and wherein said plurality of near-field receiver electrodes and said plurality of far-field receiver electrodes are configured to simultaneously couple with said plurality of transmitter electrodes.

16. The transcapacitive input device of claim 15, further comprising:
a processing system coupled with said plurality of transmitter electrodes, said plurality of near-field receiver electrodes, and said plurality of far-field receiver electrodes.

17. The transcapacitive input device of claim 16, wherein said processing system is configured to simultaneously receive near-field resulting signals from said near-field receiver electrodes and far-field resulting signals from said far-field receiver electrodes.

18. The transcapacitive input device of claim 15, wherein the surface area of any of said plurality of near-field receiver electrodes is less than the surface area of any of said plurality of far-field receiver electrodes.

19. The transcapacitive input device of claim 15, wherein said near-field receiver electrodes and said plurality of far-field receiver electrodes are disposed in the same layer as one another above a substrate.

20. The transcapacitive input device of claim 15, wherein said near-field receiver electrodes, said plurality of far-field receiver electrodes, and said plurality of transmitter electrodes are disposed in the same layer as one another above a substrate.

21. The transcapacitive input device of claim 15, wherein said near-field and far-field receiver electrodes are disposed orthogonally to said transmitter electrodes.

22. The transcapacitive input device of claim 15, wherein said pair of said near-field receiver electrodes are ohmically coupled together.

23. The transcapacitive input device of claim 15, wherein a pitch of said far-field receiver electrodes is greater than a pitch of said near-field receiver electrodes.
